(19) United States
(12) Patent Application Publication
(10) Pub. No.: US 2010/0042357 A1
(43) Pub. Date: Feb. 18, 2010

(54) Manipulator Position Sensor System

(75) Inventors: Richard W. McCoy, JR., Cypress, TX (US); Todd Granger Holtz, Houston, TX (US)

Correspondence Address: DUANE MORRIS LLP - Houston, 3200 SOUTHWEST FREEWAY, SUITE 3150, HOUSTON, TX, 77027, US

(73) Assignee: Oceaneering International, Inc., Houston, TX (US)

(21) Appl. No.: 12/192,209

(22) Filed: Aug. 15, 2008

(51) Int. Cl. G01P 15/00

(52) U.S. Cl. 702/141

(57) ABSTRACT

A system and method for determining a position of an articulated member with respect to a predetermined plane comprise a multi-axis accelerometer mounted to a first movable member of an articulated set of members. The multi-axis accelerometer produces a sinusoidal signal in proportion to a position of the member with respect to a predetermined set of axes of a predetermined plane. An motion controller operatively in communication with the multi-axis accelerometer determines the angle of inclination as the arctangent of two readings obtained from the accelerometer.

### BACKGROUND OF THE INVENTION

Spatially correspondent manipulators are generally equipped one or more position-feedback sensors that allow an associated control system to monitor the relative position of the manipulator members, e.g. a set of robotic arms and/or its joints, with respect to each other. These sensors may be in the form of a potentiometer, incremental or absolute encoder, resolver, or magnetic (Hall or anisotropic magneto restrictive device) sensor.

The position information determined by each of the sensors may be communicated to a control computer or control electronics using discrete wiring (separate signal wires for each sensor) or may share wiring by using some kind of communications bus (Ethernet, Arcnet, CAN, RS-485, etc.).

In the prior art, the manipulator must be designed in such a way as to allow these sensors to be incorporated into the rotating joints of the manipulator arm or in linear actuators that move the arm segments. This can complicate the design of the arm and/or add considerable cost. In some cases, it may degrade the reliability of the arm.

### DESCRIPTION OF THE FIGURES

FIG. 1 is a view in partial perspective of an exemplary system illustrating multiple accelerometers attached to multiple members of an apparatus.

### DESCRIPTION OF EXEMPLARY EMBODIMENTS

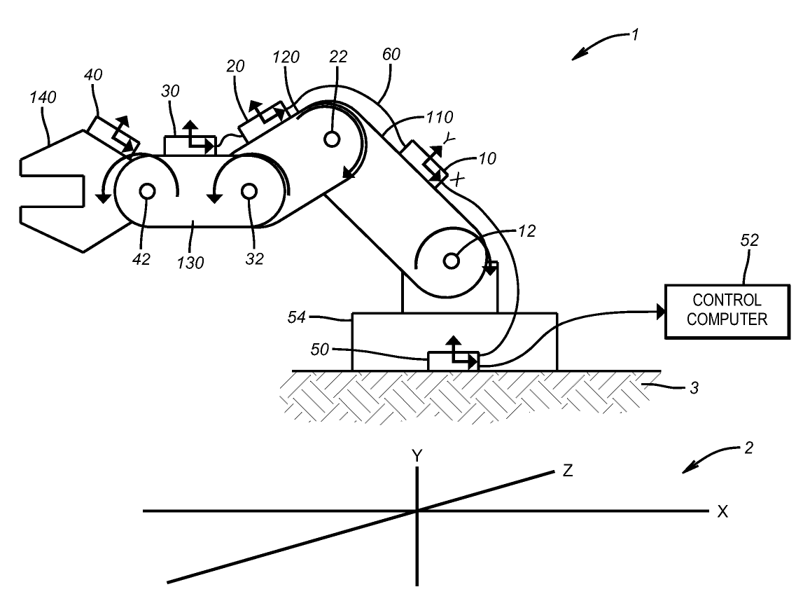

Referring now to FIG. 1, position sensor system 1 provides for determination a position of an articulated member with respect to a predetermined plane. Position sensor system 1 comprises accelerometer 10 mounted to an articulated member, e.g. 110, and motion controller 52 operatively in communication with accelerometer 10. As used herein, motion controller 52 may comprise an angle calculator.

Typically, accelerometer 10 is a multi-axis accelerometer, in a preferred embodiment a two- or three-axis accelerometer. Micro-Electro-Mechanical Systems (MEMs) devices from companies like Analog Devices or ST Microelectronics may be suitable devices for use as accelerometer 10. In a preferred embodiment, accelerometer 10 produces a sinusoidal signal in proportion to a position of member 110, to which accelerometer 10 is mounted, with respect to a specific axis or set of axes of a predetermined reference plane, e.g. plane 2. For example, if member 110 was parallel to plane 2 and further substantially parallel to earth 3, accelerometer 10 would produce a signal reflecting a zero G force in its X axis and a signal reflecting a one G force in its Y axis. Similarly, if member 110 was vertical to plane 2 which is further substantially parallel to earth 3, accelerometer 10 would produce a signal reflecting a one G force in its X axis and a signal reflecting a zero G force in its Y axis. For other positions, accelerometer 10 would produce a sinusoidal signal in proportion to a position of the member 110 to which it is attached with respect to its respective reference axes of predetermined plane 2. In a preferred embodiment, the description above is suited for detecting motion in a vertical plane. In a horizontal plane, a preferred embodiment requires a rate gyro to detect motion.

Motion controller 52 is typically a microprocessor-based, embedded control computer that is used to determine a current position of members 110 and 120, e.g. manipulator arm segments, and calculate actuator inputs required to move one or more of members 110 and 120 to a desired position using one or more actuators_. Actuators may be hydraulic, pneumatic, or electrical actuators, or the like, or a combination thereof. Motion controller 52 uses appropriate algorithms such as P, PI, PD, PID, or Fuzzy logic, or Kalman Filters to determine the appropriate actuator movement to achieve motion to the desired position.

Data communications network 60 may be used to provide data communications between accelerometers 10,20 and motion controller 52. Typical data communications cabling, e.g. wired or fiber or wireless or the like, and typical data networking protocols may be used, e.g. Ethernet, Arcnet, CAN, token ring, RS-485, or the like, or a combination thereof.

Position sensor system 1 may be used terrestrially or under water, e.g. subsea. For example, members 110 and 120 may be manipulator arms attached to a remotely operated vehicle for use subsea.

As used as part of an apparatus, articulated arms may be constructed or retrofitted with position sensor system 1. Such an apparatus may comprise a plurality of members, e.g. members 110 and 120 and 130, as well as manipulators, e.g. 140, some or all of which are flexibly connected, e.g. at joint 12. Members, e.g. 110 and 120, may be of independent lengths but movably joined, e.g. using a shoulder joint, an azimuth joint, a wrist yaw joint, or the like, or a combination thereof as is appropriate. Each such member, e.g. member 120, may have its own accelerometer, e.g. accelerometer 20, in communication with motion controller 30. For shoulder, azimuth, or wrist yaw joints, a rate gyro may be used for either or both of accelerometers 10,20.

For multiple member configurations, a plurality of accelerometers, e.g. 10, 20, 30, and 40, are mounted to each respective member 110, 120, 130, 140 for which a position is to be determined. For example, first accelerometer 10 may be mounted to first member 110 and second accelerometer 20 mounted to second member 120. As above, each accelerometer 10, 20 is adapted to produce a sinusoidal signal in proportion to a position of the member 110, 120 to which that accelerometer 10, 20 is attached with respect to an axis of predetermined plane 2. As above, motion controller 52 is operatively in communication with first and second accelerometers 10,20. Controller 70 (not shown in the figures) is operatively in communication with accelerometers 10,20 and motion controller 52 so as to be able to affect movement and further positioning of members 110, 120. This can be accomplished using data communications network 60. As used herein, controller 70 may be motion controller 52.

Position sensor system 1 further allows the upgrade of existing manipulator arms, robotic arms, construction implement (backhoe for example), and the like such as by simply by attaching accelerometers 10, 20, 30, 40, 50 externally to the existing arm segments.

An additional advantage of position sensor system 1 is that it would allow for the compensation in the pitch of robotic arms attached to a remotely operated vehicle (ROV) as the pitch of the ROV changes when loads are picked up or released. With this arrangement, a control system can be configured to maintain a particular attitude of the wrist pitch irrespective of the ROV's pitch. This would allow an operator to more easily install or handle heavy objects such as flying leads.

In the operation of an exemplary embodiment, a position of articulated member 110, 120 may be determined by taking a reading from accelerometer 110 which is attached to a member 110. Member 110 may be attached to other members, e.g. member 120, such as at joints 12, 22, 32, 42. This reading will be from a predetermined axis, e.g. the X-axis, relative to predetermined plane 2. A second reading is then taken from a second axis, e.g. the Y-axis, relative to predetermined plane 2. Using these X- and Y-axis readings, an angle of inclination of member 110 with respect to predetermined plane 2 is calculated by using the X-axis measurement and the Y-axis measurement and setting the angle of inclination of member 110 as equal to the arctangent of the Y-axis measurement over the X-axis measurement.

Additionally, the apparatus to which members 110, 120, 130, 140 may be attached may not be level with respect to reference plane 50. In these environments, the X and Y accelerations of members 110, 120, 130, 140 can be measured and used to “tare” out the motions and inclination of the apparatus to which they are attached, e.g. base 54. For the shoulder azimuth and wrist yaw joints, a rate gyro would be employed, e.g. accelerometer 50 which measures angular accelerations. For example, to adjust for variances between reference plane 2 and a base plane, e.g. earth 3, base inclination measuring device 50 may be present. For example, base inclination measuring device 50 may be an accelerometer. In these configurations, a reading is obtained from accelerometer 50 mounted to base 54 where articulating members 110 and 120 are attached to base 54. This reading will be relative to predetermined plane 2 to indicate the inclination of base 54 with respect to reference plane 2. The obtained base readings are used to adjust the calculated arctangent reading obtained from members 110, 120, 130, and/or 140.

The foregoing disclosure and description of the inventions are illustrative and explanatory. Various changes in the size, shape, and materials, as well as in the details of the illustrative construction and/or a illustrative method may be made without departing from the spirit of the invention.

We claim:

1. A system for determining a position of an articulated member with respect to a predetermined plane, comprising
a. a multi-axis accelerometer mounted to a first member, the multi-axis accelerometer adapted to produce a sinusoidal signal in proportion to a position of the first member with respect to a predetermined set of axes of a predetermined plane; and
b. a motion controller operatively in communication with the multi-axis accelerometer, the motion controller adapted to determine a position of the articulated member with respect to the predetermined plane using a value of the sinusoidal signal obtained from the multi-axis accelerometer.

2. The system of claim 1 wherein the multi-axis accelerometer comprises a three-axis accelerometer.

3. The system of claim 1, further comprising a base inclination measuring device.

4. The system of claim 1, wherein the multi-axis accelerometer is adapted for use subsea.

5. The system of claim 1, wherein the multi-axis accelerometer comprises a rate gyro.

6. The system of claim 1, further comprising a data communications network, wherein the motion controller is operatively in communication with the multi-axis accelerometer using the data communications network.

7. The system of claim 8, wherein the data communications network is selected from the group of data communications networks consisting of Ethernet, Arcnet, CAN, token ring, and RS-485.

8. An articulated arm, comprising:
a. a first member;
b. a second member movably connected to the first member;
c. a first multi-axis accelerometer mounted to the first member, the first multi-axis accelerometer adapted to produce a sinusoidal signal in proportion to a position of the first member with respect to a predetermined plane;
d. a second multi-axis accelerometer mounted to the second member, the second multi-axis accelerometer adapted to produce a sinusoidal signal in proportion to a position of the second member with respect to the predetermined plane;
e. an motion controller operatively in communication with the first and second multi-axis accelerometers; and
f. a controller operatively in communication with the first member, the second member, and the motion controller.

9. The articulated arm of claim 8, wherein the first member, the second member, the first multi-axis accelerometer, and the second multi-axis accelerometer are each adapted for use subsea.

10. The articulated arm of claim 8, further comprising a data communications network, wherein the motion controller is operatively in communication with the first and second multi-axis accelerometers using the data communications network.

11. The articulated arm of claim 10, wherein the data communications network is selected from the group of data communications networks consisting of Ethernet, Arcnet, CAN, token ring, and RS-484.

12. A method of determining a position of an articulated member, comprising:
a. obtaining a reading representative of a first axis of a predetermined plane from a multi-axis accelerometer attached to an articulating member;
b. obtaining a reading representative of a second axis of the predetermined plane from the multi-axis accelerometer attached to the articulating member;
c. calculating an angle of inclination of the articulating member with respect to the predetermined plane by:
i. using the readings from the accelerometer as an X axis measurement for the predetermined plane and as a Y axis measurement of the predetermined plane; and
ii. setting the angle of inclination of the member with respect to the predetermined plane as equal to the arctangent of the Y axis measurement over the X axis measurement.

13. The method of claim 12, further comprising:
a. obtaining a predetermined set of accelerometer readings relative to the predetermined plane from an accelerometer mounted to a base to which the articulating member is attached; and
b. using the obtained base readings to adjust the calculated arctangent reading.

14. The method of claim 13, further comprising:
a. providing the arctangent reading to a controller; and
b. using the controller to affect the inclination of the articulating member relative to the predetermined plane based on the arctangent reading.

15. The method of claim 12, wherein the calculating of the angle of inclination of the articulating member with respect to the predetermined plane uses data from a rate gyro for the readings from the accelerometer.
